(19) United States
(12) Patent Application Publication
(10) Pub. No.: US 2014/0280805 A1
(43) Pub. Date: Sep. 18, 2014

(54) Two-Sided Declarative Configuration for Cloud Deployment

(71) Applicant: RACKSPACE US, INC., San Antonio, TX (US)

(72) Inventor: Ziad Sawalha, San Antonio, TX (US)

(73) Assignee: Rackspace US, Inc., San Antonio, TX (US)

(21) Appl. No.: 13/803,194

(22) Filed: Mar. 14, 2013

(51) Int. Cl. G06F 15/177

(52) U.S. Cl. CPC G06F 15/177
USPC 709/222

(57) ABSTRACT

An example system for managing an application deployment in a cloud computing environment includes a configuration engine to receive an architectural declarative description of an application, a set of environments in which to deploy an instance of the application, and a user input that is specific to the instance. The architectural declarative description includes a declarative multi-node description for an application deployment. The configuration engine determines a desired state of the application deployment in accordance with the architectural declarative description. The example system includes a plurality of target deployment engines and a target selection engine to select a set of target deployment engines based on an environment. The set of target deployment engines communicates with one or more service providers to determine the available resources in the environment. The configuration engine determines whether the environment has sufficient resources to support the desired state based on available resources in the environment.

### BACKGROUND

The present disclosure relates generally to cloud computing, and more particularly to a declarative cloud deployment system.

Cloud computing services can provide computational capacity, data access, networking/routing and storage services via a large pool of shared resources operated by a cloud computing provider. Because the computing resources are delivered over a network, cloud computing is location-independent computing, with resources being provided to end-users on demand with control of the physical resources separated from control of the computing resources.

Originally the term cloud came from a diagram that contained a cloud-like shape to contain the services that afforded computing power that was harnessed to get work done. Much like the electrical power we receive each day, cloud computing is a model for enabling access to a shared collection of computing resources—networks for transfer, servers for storage, and applications or services for completing work. More specifically, the term “cloud computing” describes a consumption and delivery model for IT services based on the Internet, and it typically involves over-the-Internet provisioning of dynamically scalable and often virtualized resources. This frequently takes the form of web-based tools or applications that a user can access and use through a web browser as if it were a program installed locally on the user's own computer. Details are abstracted from consumers, who no longer have need for expertise in, or control over, the technology infrastructure “in the cloud” that supports them. Cloud computing infrastructures may consist of services delivered through common centers and built on servers. Clouds may appear as single points of access for consumers' computing needs, and may not require end-user knowledge of the physical location and configuration of the system that delivers the services.

The cloud computing utility model is useful because many of the computers in place in data centers today are underutilized in computing power and networking bandwidth. A user may briefly need a large amount of computing capacity to complete a computation for example, but may not need the computing power once the computation is done. The cloud computing utility model provides computing resources on an on-demand basis with the flexibility to bring the resources up or down through automation or with little intervention.

### BRIEF DESCRIPTION OF THE DRAWINGS

FIG. 1 is a simplified block diagram illustrating a system for managing an application deployment in a cloud computing environment using a declarative approach, according to an embodiment.

FIG. 2 is a simplified block diagram illustrating a system for managing and monitoring the application deployment in the cloud computing environment using a declarative approach, according to an embodiment.

FIG. 3 is a simplified swim diagram illustrating a system for managing an application deployment in a cloud computing environment using a declarative approach, according to an embodiment.

FIG. 4 is another simplified swim diagram illustrating a system for managing an application deployment in a cloud computing environment using a declarative approach, according to an embodiment.

FIG. 5 is a flow chart showing a method of managing the application deployment in the cloud computing environment using a declarative approach, according to an embodiment.

FIG. 6 is a block diagram of an electronic system suitable for implementing one or more embodiments of the present disclosure.

### DETAILED DESCRIPTION

### I. Overview

### II. Example Deployment System

A. Configuration Information
1. Architectural declarative description
2. Environment
3. User Inputs

B. Available Resources in the Environment

C. Application Deployment

### III. Example Monitoring System

### IV. Example Methods

### V. Example Computing System

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

An application deployed in a target environment is typically installed manually or in an automated fashion using scripts. In an example, a user may wish to deploy an application on four web servers running on port 80. To do so, the user may run a script to configure the four servers accordingly. A failure during script execution may be hard to remedy because the script does not inform the user of the desired state of the system.

Further, even if the application had been installed correctly, a client attempting to access the application may not be able to access it later. This may occur, for example, if the port number was changed from port 80 to another port. If a problem arises such that the server state no longer matches its desired configuration (e.g., available on port 80), all of the web servers to which the application are deployed may need to be checked manually to determine their port availability. This may be an expensive and cumbersome process. Additionally, re-executing the script to configure the four servers may break the servers if the scripts are meant to be run only once (e.g., to set the server port to port 80).

It may be difficult to have a repeatable process for deploying and monitoring the application in the cloud computing environment. It may be beneficial to manage the application deployment in the cloud computing environment using a declarative approach. This approach and is benefits are presented below.

### II. Example Deployment System

Referring now to FIG. 1, an embodiment of a system 100 for managing an application deployment in a cloud computing environment using a declarative approach is illustrated. System 100 includes a configuration manager 110 connected to a network 104 such as, for example, a Transport Control Protocol/Internet Protocol (TCP/IP) network (e.g., the Internet). System 100 also includes a service provider 140 and a service provider 150 connected to network 104. Configuration manager 110 may communicate with service providers 140 and 150 over network 104.

### A. Configuration Information

Configuration manager 110 includes a configuration engine 112 and is coupled to deployment and management database 114. Configuration engine 112 may receive an architectural declarative description of an application, a set of environments in which to deploy an instance of the application, and one or more user inputs that is specific to the instance. Each of these inputs is further described below.

### 1. Architectural Declarative Description

The architectural declarative description may define the architecture of the application. For example, the architectural declarative description may include a description of resources to run the application, how to deploy the application, components, relationships between components, or a combination of these. A component may be a primitive building block of an application deployment and may be supplied as part of an application deployment or looked up from a server.

A drafter (e.g., person or machine) understanding the architecture of the application may create the architectural declarative description of the application. For example, the drafter may understand that the application needs more than 1 gigabyte to work well and accordingly may specify this information in the architectural declarative description of the application. In an example, the end user creates the architectural declarative description and stores the created architectural declarative description in deployment and management database 114.

In another example, the end user searches a public repository that stores one or more architectural declarative descriptions of the application and selects an architectural declarative description from the public repository. The public repository storing the architectural declarative descriptions may be architectural declarative descriptions database 160, which is coupled to network 104 and accessible over network 104 to other users. An advantage of the public repository may be that different architectural declarative descriptions of the application may be shared amongst users. In this way, users may enjoy best practices by collaborating with each other and sharing their experiences with a particular architectural declarative description. For instance, users may rate the architectural declarative descriptions, providing the end user with confidence in selecting that particular architectural declarative description. Another advantage of the public repository may be that the end user has access to architectural declarative descriptions of the application without hiring an expert to create the architectural declarative description. This may reduce costs associated with application deployment.

The architectural declarative description may describe in a declarative way the desired end state of the application deployment. The architectural declarative description of an application may include a declarative multi-node description for deploying the application. In an example, the declarative multi-node description includes a canonical description of cloud resources (e.g., compute nodes) for the application deployment. In this way, the declarative multi-node description may include a generic description that can be used for deployments of the application in different environments. A cloud resource may be, for example, a cloud server, cloud load balancer, cloud database, cloud block storage volume, cloud network, cloud object store container, and cloud domain name server.

In another example, the architectural declarative description may include a MySQL® database. Trademarks are the property of their respective owners. Configuration engine 112 may determine a desired state of the application deployment in accordance with the architectural declarative description of the application as will be further described below.

The architectural declarative description may further define policies such as, for example, a scaling policy, routing policy, or development policy. The scaling policy may specify properties that define when to scale the system. In an embodiment, configuration engine 112 adds or removes components (e.g., servers) based on the scaling policy. Further, the routing policy may specify virtual hostnames and allowable protocols for the application. Further, the development policy may specify different requirements for different environments. For example, the architectural declarative description may specify for a production environment four servers, each having two gigabytes, and for a testing environment two servers, each having 512 megabytes. In this way, the testing environment used to develop the application may use fewer resources compared to the production environment.

### 2. Environment

As discussed above, configuration engine 112 may receive the set of environments in which to deploy the instance of the application. In particular, the end user may define one or more environments in which to deploy the application, and the application may be launched and managed in an environment of the set of environments. The environment may be a declarative statement of possible capabilities. Examples of the environment are a development laptop, a service provider, a geographic location (e.g., United States or United Kingdom), and a combination of service providers that a user has grouped together as a single environment. These are examples of an environment and are not intended to be limiting.

Each service provider may provide cloud resources that are specific to the service provider. In an example, service provider 140 may provide a type of server that is not provided by service provider 150. Similarly, service provider 150 may provide a type of server that is not provided by service provider 140. To avoid using different declarative multi-node descriptions for each environment, the declarative multi-node description may include a canonical description of compute nodes for the application deployment. The declarative multi-node description may include a generic description that can be used for deployments of the application in different environments. In an example, the declarative multi-node description specifies in generic terms that two servers are to be used in the application deployment. The same declarative multi-node description may then be used to deploy the application in an environment of service provider 140 and/or an environment of service provider 150. For example, service provider 140 may launch two servers specific to the environment of service provider 140.

### 3. User Inputs

As discussed above, configuration engine 112 may receive one or more user inputs that are specific to the instance. An example of a user input may be a uniform resource location (URL) or domain name. Configuration manager 110 may deploy an instance of the application using the URL. Another example of a user input is a username and password. For instance, the user may have an account including a testing environment and a production environment and have different passwords for each environment. In this way, the user may avoid mistakenly running the test against the production environment. These are examples of a user input and are not intended to be limiting.

The architectural declarative description of the application may include options that are available to the user. In an example, the architectural declarative description includes options for the user that determine a final deployment topology and the values that go into the individual component options. Additionally, the architectural declarative description may include constraints on the application deployment. For example, the architectural declarative description of the application may limit the options of the user input. In an example, the architectural declarative description may specify that the application deployment use four servers. In this example, the architectural declarative description may not give the user the option to enter a quantity of servers for the deployment because the quantity of servers is fixed at four. In another example, the architectural declarative description may specify that the application deployment use four, six, or eight servers. In this example, the architectural declarative description may give the user the option to enter four, six, or eight as the quantity of servers to launch.

In an embodiment, the user may be restricted from overriding the limited options included in the architectural declarative description of the application. In this way, the user may safely use the architectural declarative description knowing that the drafter's intent will be maintained. In another embodiment, the user may override the limited options included in the architectural declarative description of the application.

In an example, configuration engine 112 may receive the architectural declarative description specifying two servers having two gigabytes each, an environment including service provider 150, and a user input of “www.test.com.” Configuration engine 112 may determine that the desired state is two servers, having two gigabytes each, launched by service provider 150 using the URL “www.test.com.” Configuration manager 110 may launch these servers in service provider 150, configure the servers, and configure the URL. After the application is deployed, the end user may point a browser at the URL “www.test.com” to access the test deployment running in service provider 150. In another example, the architectural description does not specify a number of compute nodes. For example, as described further below, the architectural declarative description may include a MySQL® database, and configuration manager 110 may determine the steps to launch the database, where a different number of cloud resources are used depending on the capabilities of service providers 140 and 150.

### B. Available Resources in the Environment

Referring back to FIG. 1, system 100 includes target deployment engines 116 and 118 and a target selection engine 120. Each of the target deployment engines communicates with a service provider. Target selection engine 120 may select a set of target deployment engines of the plurality of target deployment engines to communicate with one or more service providers. Target selection engine 120 may select the set of target deployment engines based on the environment. A dashed line 170 indicates that target deployment engine 116 communicates with service provider 140, and a dashed line 172 indicates that target deployment engine 118 communicates with service provider 150. Target deployment engine 116 may understand communications specific to service provider 140 and not understand communications specific to service provider 150. Similarly, target deployment engine 118 may understand communications specific to service provider 150 and not understand communications specific to service provider 140. Accordingly, if the environment includes service provider 140, target selection engine may select target deployment engine 116, and if the environment includes service provider 150, target selection engine may select target deployment engine 118.

The set of target deployment engines communicates with one or more service providers to determine the available resources in the environment. In an embodiment, the architectural declarative description includes a declarative multi-node description including a canonical description of compute nodes for the application deployment. The set of target deployment engines may translate the canonical description of the compute nodes into compute nodes that are specific to the one or more service providers and that satisfy the desired state.

Further, a different number of cloud resources may be used based on the environment and target deployment engine type. A quantity of cloud resources that may be launched in the environment may be based on a type of one or more target deployment engines of the set of target deployment engines. In an example, a quantity of compute nodes that may be launched in the environment is based on a type of one or more target deployment engines of the set of target deployment engines. For example, a target deployment engine may communicate with a cloud service provider. If a MySQL database is requested, the cloud service provider may launch a server and install MySQL on the launched server. Accordingly, in this implementation, configuration manager 110 may manage two cloud resources, both the compute node and the database. In another example, a deployment engine may communicate with a cloud database service provider. The cloud database service provider may be able to launch a database on its own and send to configuration manager 110 the information about the database (e.g., IP address). Accordingly, in this implementation, configuration manager 110 may only have one cloud resource to manage, the database as a resource.

In an example, the same architectural declarative description may be used to determine whether service provider 140 or service provider 150 has sufficient resources to support the desired state. If the environment includes service provider 140, target deployment engine 116 may translate a canonical description of the compute nodes into compute nodes that are specific to service provider 140. Similarly, if the environment includes service provider 150, target deployment engine 118 may translate the canonical description of the compute nodes into compute nodes that are specific to service provider 150.

For instance, the architectural declarative description may specify four servers that connect to a high bandwidth network, and the end user may wish to deploy the application on the end user's cloud account. To get a better idea of which service provider to use, the end user may select this architectural declarative description and specify an environment including service provider 140 in which to deploy an instance of the application. Based on the environment including service provider 140, target selection engine 120 may select target deployment engine 116, which communicates with service provider 140. Target deployment engine 116 may then communicate with service provider 140, and based on this communication service provider 140 may expose public application programming interfaces (APIs) 142. Target deployment engine 116 may invoke one or more API calls local to service provider 140 and receive responses responsive to the one or more API calls. The API calls 142 local to service provider 140 may be different from API calls 152 local to service provider 150. In particular, API calls 142 may not work on service provider 150, and API calls 152 may not work on service provider 140.

In an example, target deployment engine 116 may invoke public APIs 142 to determine the available resources in the environment. Configuration engine 112 may determine whether the environment has sufficient resources to support the desired state based on the available resources in the environment. If configuration engine 112 determines that the environment has insufficient resources to support the desired state based on the available resources in the environment, configuration engine 112 may send a communication to the user that the environment has insufficient resources to support the desired state. The user may then use the same architectural declarative description to determine whether a second environment (e.g., service provider 150) has sufficient resources to support the desired state.

Alternatively, if configuration engine 112 determines that the environment has sufficient resources to support the desired state based on the available resources in the environment, configuration engine 112 may send a communication to the user that the environment has sufficient resources to support the desired state. Configuration engine 112 may inform the user of the specifics of the potential application deployment in the environment such as the types of servers to be launched, the quantity of servers to be launched, and the cost associated with the deployment. Configuration engine 112 may then ask the user whether he or she would like to deploy an instance of the application in the environment.

### C. Application Deployment

The user may select to deploy an instance of the application in the environment. As a result, configuration manager 110 may create a live deployment that matches the desired state, and the deployment may result in a fully built and running, multi-component application.

After configuration engine 112 determines that the environment has sufficient resources to support the desired state, configuration engine 112 may deduce from the architectural declarative description including the declarative multi-node description a workflow to satisfy the desired state. Configuration engine 112 may then execute the workflow to create the desired state in the environment. The set of target deployment engines may send one or more communications to the one or more service providers to cause the one or more service providers to deploy the instance of the application in the environment based on the workflow.

The set of target deployment engines may request resources from the appropriate service providers. In an example, the set of target deployment engines invokes one or more API calls local to the one or more service providers to cause the one or more service providers to launch in the environment the compute nodes specific to the one or more service providers. For instance, if the architectural declarative description specifies four servers that connect to a high bandwidth network and service provider 140 has sufficient resources to launch the four servers having a connection to a high bandwidth network, target deployment engine 116 may invoke one or more API calls local to service provider 140 to launch the multiple compute nodes (e.g., four servers having the connection to the high bandwidth network) specific to the environment of service provider 140. The set of target deployment engines may receive responses in response to the API calls. In an example, a target deployment engine of the set of target deployment engines may receive an Internet Protocol address of the launched compute node in response to the one or more communications. The target deployment engine may also receive other information regarding the launched compute node, such as how much memory is available in the launched computer node. The target deployment engine may then store the received data in deployment and management database 114.

The end user may have an account including multiple environments. In an example, the user may have a development, testing, staging, and production environment defined in the account. Deployment and management database 114 may include the account information. Configuration manager 110 may manage which resources belong in which environments by searching deployment and management database 114.

The architectural declarative description of the application may be used for separate deployments. In an example, the end user may have test accounts on service provider 140 and production accounts on service provider 150. The end user may have these different accounts for a variety of reasons. For example, service provider 140 may be less expensive and suitable for the testing environment, and service provider 150 may be more stable and more suitable for the production environment. In an example, the end user input includes a URL “www.test.com” that is specific to the deployment. The one or more communications to the one or more service providers may include a communication to cause the one or more service providers to deploy the instance of the application on servicer provider 140 using the URL.

The end user may then wish to deploy the application in the production environment using the same architectural declarative description that was used to deploy the application in service provider 140 using “www.test.com.” Accordingly, configuration engine 112 may receive a second environment (e.g., service provider 150) in which to deploy a second instance of the application and may receive a URL “www.production.com” that is specific to the second deployment. If configuration engine 112 determines that the second environment has sufficient resources to support the desired state, configuration engine 112 deduces from the declarative multi-node description of the application a workflow to satisfy the desired state and executes the workflow to create the desired state in the second environment. The set of target deployment engines may send one or more communications to the one or more service providers to cause the one or more service providers to deploy the second instance in the second environment based on the workflow.

As discussed above and further emphasized here, FIG. 1 is merely an example, which should not unduly limit the scope of the claims. For example, although system 100 is described herein with reference to two service providers, the configuration manager may communicate with fewer than or more than two service providers without departing from the spirit and scope of the disclosure. Further, each of configuration engine 112, target deployment engine 116, target deployment engine 118, and target selection engine 120 may include one or more modules. For example, configuration engine 112 may be split into a first configuration engine and a second configuration engine. Moreover, each of configuration engine 112, target deployment engine 116, target deployment engine 118, and target selection engine 120 may be incorporated into the same module.

Additionally, each of a server running configuration manager 110, service provider 140, and service provider 150 typically includes a respective information processing system, a subsystem, or a part of a subsystem for executing processes and performing operations (e.g., processing or communicating information). An information processing system is an electronic device capable of processing, executing or otherwise handling information, such as a computer. FIG. 7 shows an example information processing system 700 that is representative of one of, or a portion of, the information processing systems described above. Examples of information processing systems include a server computer, a personal computer (e.g., a desktop computer or a portable computer such as, for example, a laptop computer), a handheld computer, and/or a variety of other information handling systems.

### III. Example Monitoring System

Configuration manager 110 may verify that the application is running properly and may also perform troubleshooting. FIG. 2 is a simplified block diagram illustrating a system 200 for managing and monitoring the application deployment in the cloud computing environment using a declarative approach, according to an embodiment. System 200 includes configuration manager 110 coupled to deployment and management database 114. Configuration manager 110 includes configuration engine 112, target deployment engines 116 and 118, and target selection engine 120.

In FIG. 2, configuration manager 110 further includes a monitor 202 that monitors the state of the application deployment. Monitor 202 may maintain and monitor the live deployment. In an embodiment, the end user sends a request to configuration manager 110 to determine whether the desired configuration of the deployment matches the current state of the deployment. In another embodiment, configuration manager 110 is on a schedule and determines whether the desired configuration of the deployment matches the current state of the deployment based on the schedule.

Monitor 202 includes a state engine 204 and a matching engine 206. State engine 204 may determine a desired configuration of a launched compute node based on the desired state. State engine 204 may determine the desired configuration based on the architectural declarative description. State engine 204 may also determine a current state of the launched compute node. In an example, a target deployment engine may send one or more communications to servers launched by the service provider for state information and receive responses based on the one or more communications. State engine 204 may determine the current state of the servers based on the one or more communications between the target deployment engine and the servers launched by the service provider. The target deployment engine may retrieve the information associated with the servers launched by the service provider from, for example, deployment and management database 114. In an example, the target deployment engine may retrieve an IP of the launched server to communicate with the server.

Matching engine 206 may determine whether the desired configuration matches the current state. If matching engine 206 determines that the desired configuration matches the current state, configuration engine 112 may inform the user that the deployment is running properly. In contrast, if matching engine 206 determines that the desired configuration does not match the current state, configuration engine 112 may deduce a workflow to return the current state of the launched compute node to the desired configuration.

In an embodiment, configuration manager 110 detects a state change in the current state of the launched compute node. The state change to monitor may be set by the end user. For example, the end user may instruct configuration manager 110 to monitor port 80 on the launched servers, and configuration manager 110 may detect when changes of this nature occur. State engine 204 may identify the state change in the current state of the launched compute node, and matching engine 206 may determine whether the state change in the current state matches the desired configuration. If matching engine 206 determines that the state change in the current state matches the desired configuration, configuration engine 112 may inform the user that the deployment is running properly. In contrast, if matching engine 206 determines that the state change in the current state does not match the desired configuration, configuration engine 112 may deduce a workflow to return the state of the launched compute node to the desired configuration.

### IV. Example Methods

FIG. 3 is a simplified swim diagram illustrating a method of managing an application deployment in a cloud computing environment using a declarative approach, according to an embodiment.

In FIG. 3, in a step 302, a user sends a configuration document 304 to configuration manager 110. In an embodiment, the configuration document is in a markup language, such as YAML (Yet Another Markup Language), XML (Extensible Markup Language), or HTML (Hypertext Markup Language). Configuration document 304 may also be in a format, such as JSON (JavaScript Object Notation). An advantage of having configuration document 304 in a markup language or in JSON is that configuration document 304 is machine readable and also easily readable to a human being. The list of markup languages and format is an example and not intended to be limiting.

In a step 306, configuration engine 112 receives configuration document 304 including the architectural declarative description, environment, and one or more user inputs. The architectural declarative description specifies “MySQL Database”, the environment specifies service providers 140 and 150, and the user input specifies “www.test.com.” Configuration engine 112 determines a desired state of the application deployment in accordance with the architectural declarative description of the application. Configuration document 304 includes a MySQL database. Configuration engine 112 may know the desired state, but not yet know how to arrive at the desired state.

In a step 308, target selection engine 120 selects a set of target deployment engines of the plurality of target deployment engines based on the environment. The plurality of target deployment engines includes target deployment engine 116, target deployment engine 118, and target deployment engine 310. Target deployment engine 116 may communicate with service provider 140, target deployment engine 118 may communicate with service provider 150, and target deployment engine 310 may communicate with service provider 312. The end user may group service providers together as a single environment. For instance, in configuration document 304 the environment includes service providers 140 and 150. Accordingly, target selection engine 120 selects target deployment engines 116 and 118.

In a step 320, target deployment engine 116 may communicate with service provider 140, and in a step 322, target deployment engine 118 may communicate with service provider 150. Target deployment engine 116 may invoke one or more public APIs 142 local to service provider 140 to determine available resources of service provider 140, and target deployment engine 118 may invoke one or more public APIs 152 local to service provider 150 to determine available resources of service provider 150.

Configuration engine 112 may determine whether service providers 140 and 150 have sufficient resources to support the desired state based on the available resources in the environment. In an example, service provider 140 is a cloud service provider that launches compute nodes, service provider 150 is a cloud database service provider that can launch database systems, and service provider 312 is a virtualization engine on a laptop (e.g., VM Ware). Target selection engine 120 may select target deployment engines 116 and 118. Target deployment engine 116 may communicate with service provider 140 to launch a compute node in which to install a Web server. Target deployment engine 116 may send the information associated with the compute node to configuration manager 110. Target deployment engine 118 may communicate with service provider 150 to launch the database system. Target deployment engine 118 may send the information associated with the database system to configuration manager 110. Configuration manager may maintain and monitor the status information of the compute node with the installed Web server and the database system.

In another example, target deployment engine 116 may determine that service provider 140 has three servers available, each having four gigabytes, and target deployment engine 118 may determine that service provider 150 has two servers available, each having two gigabytes. In this example, configuration engine 112 may determine that service providers 140 and 150 have sufficient resources to support the desired state. If service provider 140 is used to deploy the application, three servers may be used. If service provider 150 is used to deploy the application, two servers may be used.

In another example, target deployment engine 116 may determine that service provider 140 has one server available, the server having four gigabytes, and target deployment engine 118 may determine that service provider 150 has two servers available, each having one gigabyte. In this example, configuration engine 112 may determine that service providers 140 and 150 have insufficient resources to support the desired state.

FIG. 4 is another simplified swim diagram illustrating a method of managing an application deployment in a cloud computing environment using a declarative approach, according to an embodiment.

In FIG. 4, the architectural declarative description specifies “MySQL Database”, the environment specifies service provider 312, and the user input specifies “www.test.com.” In an example, target deployment engine 310 may know that it does not have a database creation API. To provide a database to the user, target deployment engine 310 may communicate with service provider 312 to launch a compute node and install MySQL on it. Target deployment engine 310 may then provide to configuration manager 110 a pointer to the compute node.

FIG. 5 is a flow chart showing a method 500 of managing an application deployment in a cloud computing environment using a declarative approach, according to an embodiment. Method 500 is not meant to be limiting and may be used in other applications.

Method 500 includes steps 510-570. In a step 510, an architectural declarative description of an application is received. In an example, configuration engine 112 receives an architectural declarative description of an application.

In a step 520, a set of environments in which to deploy an instance of the application is received. In an example, configuration engine 112 receives a set of environments in which to deploy an instance of the application.

In a step 530, one or more user inputs that is specific to the instance is received. In an example, configuration engine 112 receives one or more user inputs that is specific to the instance.

In a step 540, a desired state of the application deployment is determined in accordance with the architectural declarative description of the application. In an example, configuration engine 112 determines a desired state of the application deployment in accordance with the architectural declarative description of the application.

In a step 550, a set of target deployment engines of a plurality of target deployment engines is selected based on the environment, the set of target deployment engines communicating with a set of service providers to determine the available resources in the environment. In an example, target deployment engine 116 selects a set of target deployment engines of a plurality of target deployment engines based on the environment, the set of target deployment engines communicating with a set of service providers to determine the available resources in the environment.

In a step 560, it is determined whether an environment of the set of environments has sufficient resources to support the desired state based on available resources in the environment. In an example, configuration manager 110 determines whether an environment of the set of environments has sufficient resources to support the desired state based on available resources in the environment.

It is also understood that additional method steps may be performed before, during, or after steps 510-560 discussed above. For example, method 500 may include a step of after determining that the environment has sufficient resources to support the desired state, deducing from the declarative multi-node description of the application a workflow to satisfy the desired state. It is also understood that one or more of the steps of method 500 described herein may be omitted, combined, or performed in a different sequence as desired. For example, step 520 may be performed before step 510.

### V. Example Computing System

FIG. 6 is a block diagram of a computer system 600 suitable for implementing one or more embodiments of the present disclosure. In various implementations, host machine 101 may include a client or a server computing device. The client or server computing device may include one or more processors. The client or server computing device may additionally include one or more storage devices each selected from a group consisting of floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to the client or server using a computer network (not shown). The computer network may be any type of network including a LAN, a WAN, an intranet, the Internet, a cloud, and/or any combination of networks thereof that is capable of interconnecting computing devices and/or computer programs in the system.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component such as a display 611, and an input control such as a cursor control 613 (such as a keyboard, keypad, mouse, etc.). An optional audio input/output component 605 may also be included to allow a user to use voice for inputting information by converting audio signals into information signals. Audio I/O component 605 may allow the user to hear audio. A transceiver or network interface 606 transmits and receives signals between computer system 600 and other devices via a communication link 618 to a network. In an embodiment, the transmission is wireless, although other transmission mediums and methods may also be suitable. A processor 612, which may be a micro-controller, digital signal processor (DSP), or other processing component, processes these various signals, such as for display on computer system 600 or transmission to other devices via communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 614, and transmission media includes coaxial cables, copper wire, and fiber optics, including wires that include bus 602. In an embodiment, the logic is encoded in non-transitory computer readable medium. In an example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. In an example, configuration manager 110 may be a software module running in a server. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A system for managing an application deployment in a cloud computing environment, the system comprising:
a configuration engine to receive an architectural declarative description of an application, to receive a set of environments in which to deploy an instance of the application, and to receive one or more user inputs that is specific to the instance,
wherein the configuration engine determines a desired state of the application deployment in accordance with the architectural declarative description of the application and further determines whether an environment of the set of environments has sufficient resources to support the desired state based on available resources in the environment;
a plurality of target deployment engines, wherein each target deployment engine communicates with a service provider; and
a target selection engine to select a set of target deployment engines of the plurality of target deployment engines based on the environment, wherein the set of target deployment engines communicates with a set of service providers to determine the available resources in the environment.

2. The system of claim 1, wherein the architectural declarative description comprises a canonical description of cloud resources for the application deployment, and the set of target deployment engines translates the canonical description of the cloud resources into cloud resources that are specific to the set of service providers and that satisfy the desired state.

3. The system of claim 2, wherein after the configuration engine determines that the environment has sufficient resources to support the desired state, the configuration engine deduces from the architectural declarative description of the application a workflow to satisfy the desired state and executes the workflow to create the desired state in the environment.

4. The system of claim 3, wherein the set of target deployment engines sends one or more communications to the set of service providers to cause the set of service providers to launch the cloud resources in the environment based on the workflow.

5. The system of claim 4, wherein the set of service providers launches a first quantity of cloud resources in the environment, wherein the first quantity is based on a type of one or more target deployment engines of the set of target deployment engines.

6. The system of claim 5, wherein the configuration engine receives a second environment in which to deploy a second instance of the application, receives one or more user inputs that is specific to the second instance, and determines whether the second environment has sufficient resources to support the desired state based on available resources in the second environment, wherein the target selection engine selects a second set of target deployment engines of the plurality of target deployment engines based on the second environment, and wherein the second set of target deployment engines communicates with a second set of service providers to determine the available resources in the second environment.

7. The system of claim 6, wherein the second set of service providers launches a second quantity of cloud resources in the second environment, wherein the second quantity is based on a type of one or more target deployment engines of the second set of target deployment engines, and the first quantity of launched cloud resources is different from the second quantity of launched cloud resources.

8. The system of claim 7, further comprising:
a monitor that monitors the launched cloud resources in the first environment and that monitors the launched cloud resources in the second environment.

9. The system of claim 4, wherein a target deployment engine of the set of target deployment engines receives identifying information of a launched cloud resource of the first quantity of cloud resources.

10. The system of claim 9, further comprising a monitor to determine a desired configuration of the launched cloud resource based on the desired state, to determine a current state of the launched cloud resource, and to determine whether the desired configuration matches the current state.

11. The system of claim 10, wherein after the monitor determines that the desired configuration does not match the current state, the configuration engine deduces a workflow to return the current state of the launched cloud resource to the desired configuration.

12. The system of claim 10, wherein the monitor detects a state change in the current state of the launched cloud resource and determines whether the state change in the current state matches the desired configuration.

13. The system of claim 12, wherein after the monitor determines that the desired configuration does not match the state change in the current state, the configuration engine deduces a workflow to return the state of the launched cloud resource to the desired configuration.

14. The system of claim 2, wherein a cloud resource is at least one of a cloud server, cloud load balancer, cloud database, cloud block storage volume, cloud network, cloud object store container, and cloud domain name server.

15. The system of claim 1, wherein the set of target deployment engines invokes one or more API calls local to the set of service providers to determine the available resources in the environment.

16. The system of claim 15, wherein the set of target deployment engines invokes one or more API calls local to the set of service providers to cause the set of service providers to launch in the environment the cloud resources specific to the set of service providers.

17. The system of claim 1, wherein the architectural declarative description of the application limits options of the one or more user inputs.

18. The system of claim 1, wherein the configuration engine receives a configuration document comprising the architectural declarative description, the environment, and the one or more user inputs, and wherein the configuration document is in a markup language.

19. A method of managing an application deployment in a cloud computing environment, the method comprising:
receiving an architectural declarative description of an application;
receive a set of environments in which to deploy an instance of the application;
receiving one or more user inputs that is specific to the instance,
determining a desired state of the application deployment in accordance with the architectural declarative description of the application;
determining whether an environment of the set of environments has sufficient resources to support the desired state based on available resources in the environment; and
selecting a set of target deployment engines of a plurality of target deployment engines based on the environment, the set of target deployment engines communicating with a set of service providers to determine the available resources in the environment.

20. The method of claim 19, wherein the receiving an architectural declarative description of an application comprises receiving a canonical description of cloud resources for the application deployment, the method further comprising:
translating the canonical description of the cloud resources into cloud resources that are specific to the set of service providers and that satisfy the desired state.

21. The method of claim 20, further comprising:
after determining that the environment has sufficient resources to support the desired state, deducing from the architectural declarative description of the application a workflow to satisfy the desired state; and
executing the workflow to create the desired state in the environment.

22. The method of claim 21, wherein the executing the workflow comprises sending one or more communications to the set of service providers to cause the set of service providers to launch the cloud resources in the environment based on the workflow.

23. The method of claim 22, wherein the sending one or more communications to the set of service providers to cause the set of service providers to launch the cloud resources in the environment comprises sending one or more communications to the set of service providers to cause the set of service providers to launch a first quantity of cloud resources in the environment, the first quantity being based on a type of one or more target deployment engines of the set of target deployment engines.

24. The method of claim 23, further comprising:
receiving a second environment in which to deploy a second instance of the application;
receiving one or more user inputs that is specific to the second instance;
selecting a second set of target deployment engines of the plurality of target deployment engines based on the second environment;
sending one or more communications to a second set of service providers to determine the available resources in the second environment; and
determining whether the second environment has sufficient resources to support the desired state based on the available resources in the second environment.

25. The method of claim 24, wherein the first set of service providers launches a first quantity of cloud resources in the first environment, the second set of service providers launches a second quantity of cloud resources in the second environment, the second quantity is based on a type of one or more target deployment engines of the second set of target deployment engines, and the first quantity is different from the second quantity.

26. The method of claim 16, further comprising:
determining a desired configuration of the launched compute node based on the desired state;
determining a current state of the launched compute node;
determining whether the desired configuration matches the current state; and
if the desired configuration is determined to not match the current state, deducing a workflow to return the current state of the launched compute node to the desired configuration.

27. The method of claim 19, further comprising:
identifying a state change in the current state of the launched compute node;
determining whether the state change in the current state matches the desired configuration;
if the state change in the current state is determined to not match the desired configuration, deducing a workflow to return the state of the launched compute node to the desired configuration.

28. A non-transitory machine-readable medium comprising a plurality of machine-readable instructions that when executed by one or more processors is adapted to cause the one or more processors to perform a method comprising:
receiving an architectural declarative description of an application;
receive a set of environments in which to deploy an instance of the application;
receiving one or more user inputs that is specific to the instance,
determining a desired state of the application deployment in accordance with the architectural declarative description of the application;
determining whether an environment of the set of environments has sufficient resources to support the desired state based on available resources in the environment; and
selecting a set of target deployment engines of a plurality of target deployment engines based on the environment, the set of target deployment engines communicating with a set of service providers to determine the available resources in the environment.
